(19) United States
(12) Patent Application Publication
(10) Pub. No.: US 2019/0118219 A1
(43) Pub. Date: Apr. 25, 2019

(54) METHOD OF PROVIDING A METALLICALLY REFLECTIVE, HIGH-GLOSS SURFACE ON A SUBSTRATE AND LAYER SYSTEM OBTAINED BY THE METHOD

(71) Applicant: Karl Worwag Lack- und Farbenfabrik GmbH & Co. KG, Stuttgart (DE)

(72) Inventors: Markus Schmidtchen, Mosbach (DE); Jürgen Ortmeier, Kirchheim (DE); Michael Kaltenbach, Althengstett (DE)

(21) Appl. No.: 16/099,754

(22) PCT Filed: May 9, 2017
(86) PCT No.: PCT/EP2017/061075

§ 371 Date: Nov. 8, 2018

(30) Foreign Application Priority Data
May 10, 2016 (DE) 10 2016 208 046.6

(51) Int. Cl. B05D 5/06; B05D 1/02; B05D 3/00; B05D 7/00; C09D 5/00; C09D 5/08; C09D 175/06

(52) U.S. Cl. CPC B05D 5/063; B05D 1/02; B05D 3/007; C09D 175/06; B05D 7/57; C09D 5/002; C09D 5/086; B05D 5/068

(57) ABSTRACT

A method of providing a metallically reflective surface on a substrate includes applying a primer layer to the substrate, mixing a solution of silver salt with a reducing agent and spraying the solution onto the primer layer to form a silver layer, and applying at least one transparent or translucent top coat layer or at least one clear coat layer onto the silver layer, wherein the primer contains a corrosion inhibitor selected from the group consisting of benzotriazole, tolyltriazole, benzimidazole, derivatives of the compounds and mixtures of two or more of the compounds and/or derivatives.

### TECHNICAL FIELD

This disclosure relates to a method of providing a metallically reflective, high gloss surface on a substrate comprising formation of a silver layer on the substrate by mixing a solution of a silver salt with a reducing agent. The disclosure also relates to a multi-layer system and a varnished substrate with the layer system.

### BACKGROUND

The coating of surfaces of substrates can be useful for many reasons, for example, to protect the surfaces, change their physical properties (e.g., their conductivity) for decorative reasons (creating a mirror effect) or improve the structural integrity of the substrates. Therefore, the interest in methods with which a broad spectrum of different substrates can be coated is very high. Of particular importance is the coating of plastics, whereby wood, glass and metal substrates are also substrates of interest.

A well-known method for production of mirrored surfaces is the so-called spray metallization (also known as the “chemical spray process” or “CSV process”). In that process, a silver layer is deposited on a substrate by spraying, usually using a two-component spray gun in which a solution of a silver salt and a reducing solution are emitted from two separate nozzles. As soon as the solutions mix, the reducing solution reduces the silver salt contained in the salt solution and metallic silver precipitates. The precipitated silver deposits on the substrate and forms the desired mirrored surface. After cleaning and drying the mirrored surface, a transparent or translucent protective coating is usually applied.

There is a special demand for mirrored surfaces in the automotive and motorcycle sectors. In those sectors, however, demands on the quality of the mirrored surfaces are very high since automobiles and motorcycles are exposed to high levels of weathering and mechanical stress. For example, the transparent or translucent protective coating on a silver layer produced by spray metallization can be easily damaged by stone chips. As a result, the silver layer under the protective coating is accessible to weathering. Under corrosive conditions, rapid decomposition of the silver layer and thus damage to the overall optical impression of the mirrored surface can occur. Mirrored surfaces produced by spray metallization are therefore only conditionally suitable for use in the automotive and motorcycle sectors.

To increase the corrosion stability of silver coatings produced by spray metallization, substrates can be primed with a coating containing zinc particles before applying the silver coating. The zinc particles form a local cell with the silver layer and act as a sacrificial anode. Corrosive effects on the silver layer are delayed at best. However, the zinc particles in the primer must be contained in a very high proportion. A high proportion of zinc particles in the primer has a negative effect on the smoothness of the surface of the primed substrate. A reduced surface smoothness has the consequence that the silver layer applied subsequently only has a matt gloss. High-gloss surfaces cannot be achieved in this way.

It could therefore be helpful to provide mirrored, high-gloss surfaces that is less susceptible to mechanical and corrosive stresses and also suitable for use in the automotive and motorcycle sectors.

### SUMMARY

We provide a method of providing a metallically reflective surface on a substrate including applying a primer layer to the substrate, mixing a solution of silver salt with a reducing agent and spraying the solution onto the primer layer to form a silver layer, and applying at least one transparent or translucent top coat layer or at least one clear coat layer onto the silver layer, wherein the primer contains a corrosion inhibitor selected from the group consisting of benzotriazole, tolyltriazole, benzimidazole, derivatives of the compounds and mixtures of two or more of the compounds and/or derivatives.

We also provide a layer system on a substrate including a primer layer directly arranged on the substrate; a silver layer directly arranged on the primer layer; and a top coat layer directly arranged on the silver layer, wherein the primer layer contains a corrosion inhibitor selected from the group consisting of benzotriazole, tolyltriazole, benzimidazole, derivatives of the compounds and mixtures of two or more of the compounds and/or derivatives.

We further provide a substrate with the layer system on a substrate including a primer layer directly arranged on the substrate; a silver layer directly arranged on the primer layer; and a top coat layer directly arranged on the silver layer, wherein the primer layer contains a corrosion inhibitor selected from the group consisting of benzotriazole, tolyltriazole, benzimidazole, derivatives of the compounds and mixtures of two or more of the compounds and/or derivatives, obtained by the method of providing a metallically reflective surface on a substrate including applying a primer layer to the substrate, mixing a solution of silver salt with a reducing agent and spraying the solution onto the primer layer to form a silver layer, and applying at least one transparent or translucent top coat layer or at least one clear coat layer onto the silver layer, wherein the primer contains a corrosion inhibitor selected from the group consisting of benzotriazole, tolyltriazole, benzimidazole, derivatives of the compounds and mixtures of two or more of the compounds and/or derivatives.

### DETAILED DESCRIPTION

Our method utilizes some known steps. For example, a silver layer is formed on a substrate to provide a metallically reflective surface. A solution of a silver salt and a reducing agent are mixed and sprayed onto the substrate before, after or during mixing. For example, the spray gun mentioned above can be used to form the silver layer. At least one transparent or translucent top coat, preferably at least one clear coat, is applied to the silver layer formed.

However, in contrast to known methods, in an upstream step, a layer of a primer (primer layer) containing a corrosion inhibitor selected from the group consisting of benzotriazole, tolyltriazole (methyl-1H-benzotriazole) and benzimidazole, derivatives of those compounds and mixtures of two or more of those compounds and/or derivatives is applied to the substrate. The silver layer is not formed directly on the substrate, but on the primer layer.

Particularly preferably, the primer contains tolytriazole as the corrosion inhibitor.

A primer (also known as a base coat or pre-coating) primarily improves adhesion conditions for a subsequent layer. In this case, however, the layer also improves the resistance of a subsequent layer, namely the silver layer, to optical damage as a result of mechanical and corrosive stress. This is achieved with surprisingly high efficiency and without any deterioration in the surface smoothness of the primed substrate, unlike with the primer containing zinc particles. This is also important insofar as to produce a high-gloss and mirrored surface, the gloss value of the primer layer at 20° according to DIN 67530 (ISO 2813) must be >70 GU (GU =gloss units), preferably >80 GU. In accordance with our method, mirrored, high-gloss surfaces can thus also be provided.

The method provides mirrored, high-gloss surfaces where a measured value >70 GU (GU=gloss units), preferably >80 GU, is achieved when determining the gloss value at 20° according to DIN 67530 (ISO 2813). Corrosion-stable surfaces with such a high degree of gloss cannot be produced using classical methods, but they can if a primer layer with the gloss values mentioned is placed under a silver layer.

Particularly preferably, the corrosion inhibitor is contained in the primer in a proportion of 0.1 wt. % to 20 wt. %, preferably from 1 wt. % to 10 wt. %, particularly preferably from 1 wt. % to 5 wt. % based on the total mass of the primer including any solvent present.

Preferably, the primer comprises a hydroxy-functional resin and an isocyanate-functional curing agent. The isocyanate-functional curing agent is particularly preferably an IPDI-based curing agent (IPDI=Isophorone diisocyanate).

As an alternative to or in addition to the hydroxy-functional resin and the isocyanate-functional curing agent, the primer may also comprise a proportion of at least one acrylic resin.

The solution of the silver salt used is preferably an aqueous solution, in particular an aqueous alkaline solution. Preferably the solution contains at least one silver salt from the group consisting of silver nitrate, silver chloride, silver acetate, silver lactate and silver sulfonate.

Preferably, an ammonia containing solution may be added to the solution of the silver salt to prevent premature precipitation of silver, causing formation of silver diamine complexes such as [Ag(NH₃)₂]²⁺.

The reducing agent is preferably an aqueous solution containing a reducing agent. As a reducing agent, compounds from the substance classes of aldehydes, sugars or alcohols are preferably used either in pure form or in any mixtures.

The agent is particularly preferably at least one agent selected from the group consisting of glucose, lactose, methanal, ethanal, propanal, butanal, pentanal, hexanal, heptanal, octanal, nonanal, decanal, methanol, ethanol, derivatives of those compounds and mixtures of two or more of those compounds and/or derivatives.

The substrate on which the metallically reflective surface is applied is preferably a plastic part, in particular a part made of acrylonitrile butadiene styrene (ABS), glass fiber reinforced plastic (GRP), polyamide (PA), polycarbonate (PC), polybutylene terephthalate (PBT), polyethylene (PE), polypropylene (PP) or polyurethane (PUR), particularly preferably PP/EPDM (polypropylene/ethylene/propylene/diene rubber blend) or a PP copolymer.

Preferably, the surface of the substrate is cleaned and/or pre-treated before applying the primer. Pretreatment may include, for example, treatment with fluorine, plasma or flaming. Often the surface is also sanded. Cleaning can also be carried out manually by wiping with solvents with or without prior grinding or by common automated processes such as power wash or CO₂ cleaning.

Preferably, after application of the primer, preferably immediately before formation of the silver layer, at least one of the following steps is carried out: a) drying and/or at least partial curing of the primer, b) activation of the primer layer, c) rinsing, preferably with deionized water.

For example, tin-II-chloride (SnCl₂) can be used as an activating agent to activate the primer layer.

After formation of the metallic layer of silver, the method comprises at least one of the following steps: a) rinsing, preferably with deionized water, b) drying the silver layer.

As mentioned above, the silver layer is preferably covered with at least one transparent or translucent top coat, especially with at least one clear coat. Clear coats are transparent lacquers that usually consist exclusively of a binder and a solvent (conventional lacquer additives may be added additionally), i.e., contain no fillers or opaque pigments.

Particularly preferably, the at least one transparent or translucent top coat layer (analogous to the primer layer) is formed from at least one coating composition comprising a hydroxy-functional resin and an isocyanate-functional curing agent.

Preferably:

(1) the transparent or translucent top coat layer is formed from a coating composition comprising a hydroxy-functional resin and an isocyanate-functional curing agent, wherein the curing agent is an IPDI-based curing agent, or
(2) the transparent or translucent top coat layer is formed from a coating composition comprising a hydroxy-functional resin and an isocyanate-functional curing agent, wherein the curing agent is an HDI-based curing agent (HDI=hexamethylene-1,6-diisocyanate), or
(3) the transparent or translucent top coat layer is formed from two coating compositions each comprising a hydroxy-functional resin and an isocyanate-functional curing agent, wherein the curing agent in one of the coating compositions is an IPDI-based curing agent and the curing agent in the other of the two coating compositions is an HDI-based curing agent (HDI=hexamethylene 1,6-diisocyanate).

In example (3), it is preferred that a first transparent or translucent layer of the coating composition with the IPDI-based curing agent is applied directly to the silver layer. Subsequently, a second transparent or translucent layer is formed using the coating composition with the HDI-based curing agent, which together with the first transparent or translucent layer, forms the transparent or translucent top coat.

All coating compositions for production of the transparent or translucent top coat may also include a proportion of at least one acrylic resin.

Particularly preferably, at least one of the coating compositions forming the top coat, in particular the composition applied directly to the silver coat, also contains at least one of the corrosion inhibitors that may be present in the primer. Tolyltriazole is also particularly preferred as the corrosion inhibitor.

The corrosion inhibitor is preferably contained in the coating composition to form the top coat layer, in a proportion of 0.1 wt. % to 20 wt. %, preferably 1 wt. % to 10 wt. %, particularly preferably 1 wt. % to 5 wt. % based on the total mass of the coating composition including any solvent present.

The layer system is located on a substrate and comprises a primer layer located directly on the substrate, a silver layer directly on the primer layer and a top coat layer directly on the silver layer. The primer layer and optionally also the top coat layer contain at least one of the corrosion inhibitors mentioned from the group consisting of benzotriazole, tolyltriazole, benzimidazole and derivatives of these compounds.

In accordance with the above, the layer system forms a mirrored surface of the substrate with high gloss properties. When determining the gloss value of the surface at 20° according to DIN 67530 (ISO 2813), a measured value >80 GU (GU=gloss units) is usually achieved.

The layer system can be produced using the method. Numerous features of the primer layer, the silver layer and the top coat layer can be derived from the examples described above. The primer and top coat layers, for example, are preferably polyurethane layers formed from the hydroxy- and isocyanate-functional components mentioned above.

The top coat layer may consist of one transparent or translucent layer or two or more transparent or translucent layers.

The thickness of the silver layer is preferably 50 nm to 200 nm.

The thickness of the primer layer is preferably 10 μm to 100 μm, preferably 20 μm to 40 μm.

The thickness of the top coat layer is preferably 10 μm to 100 μm, preferably 25 μm to 45 μm.

Any substrate having the described layer system or which is manufactured or capable of being manufactured by the method is also the subject of this disclosure.

Further features and advantages can be taken from the following examples, on the basis of which our methods and systems are explained. The example described below is merely for the purpose of explaining and better understanding and is not to be understood in any restrictive way.

### Example 1

A plastic substrate of acrylonitrile-butadiene-styrene (ABS) should be provided with a metallically reflecting surface. For this purpose, the substrate was first cleaned with an isopropanol-water mixture and then activated by plasma treatment. Subsequently, a primer was prepared and applied to the plastic substrate. The primer was a 2-component clearcoat based on a hydroxy-functional resin mixture and an isocyanate-functional curing agent. The hydroxy-functional resin composition had the following composition:

| Part by weight | component |
|---|---|
| 0.17 | acrylate copolymer |
| 33.548 | acrylic resin |
| 18.082 | polyester polyol as hydroxy-functional resin |
| 0.037 | fatty acids, C6-C19 branched, zinc salts |
| 1.732 | Methyl-1H-benzotriazole |
| 2.544 | xylene |
| 17.243 | n-Butyl acetate |
| 10.145 | naphtha (petroleum) |
| 0.676 | Ethylbenzene |
| 15.574 | 1-Methoxypropylacetate-2 |

The composition contained benzotriazole as a corrosion inhibitor. A curing agent based on isophorone diisocyanate (IPDI) was used as the isocyanate functional curing agent.

The curing agent and the hydroxy-functional resin mixture were mixed at a ratio of 3:1 and sprayed onto the substrate. Subsequently, the plastic substrate provided with primer was dried. To activate the primer layer, the layer was first flamed. Then an activator was applied (a solution of tin-(II)-chloride with a concentration of 0.5% by weight) to rinse the plastic substrate again with deionized water.

A metal salt solution (aqueous silver nitrate solution) and a reducing agent (aqueous formaldehyde solution) were provided for application of a silver layer. The solutions were mixed with a spray gun and sprayed onto the plastic substrate provided with the activated primer layer. The substrate with the deposited silver layer was then rinsed and blown dry.

A layer of a transparent top coat was then applied to the silver layer. The top coat was a 2-component clearcoat based on a hydroxy-functional resin mixture and an isocyanate-functional curing agent. IPDI was again used as curing agent. The hydroxy-functional resin mixture had the following composition:

| Part by weight | component |
|---|---|
| 0.147 | acrylat copolymer |
| 17.731 | acrylic resin |
| 29.801 | polyester polyol as hydroxy-functional resin |
| 12.93 | Polyester resin |
| 0.01 | Diazabicyclooctane |
| 0.002 | 2-Methoxypropylacetate-2 |
| 7.014 | Xylene |
| 0.001 | Benzene |
| 9.442 | n-Butyl acetate |
| 0.127 | acetone |
| 15.440 | naphtha (petroleum) |
| 1.399 | Ethylbenzene |
| 1.423 | 1-Methoxypropylacetate-2 |
| 0.068 | Dimethoxy dipropyleneglycol |
| 0.152 | 2-Phenoxyethanol |
| 0.021 | Dipropylenglycole |
| 0.344 | 1-Methoxy-2-propanol |
| 0.001 | 2-Methoxy-1-propanol |
| 0.012 | 1,2,4-Trimethylbenzene |
| 01012 | Bis(lauroyloxy)dioctyltin |
| 0.009 | Benzoguanamin-formaldehyde resin, butylated |
| 1.02 | Hydroxyphenyl-s-triazine derivative |
| 0.84 | 2-Aminoethanol derivative |
| 0.1 | Polydimethylsiloxane |
| 1.955 | Oxirane |

The hydroxy-functional resin mixture and the curing agent were mixed in a ratio of 3:1 before application.

Finally, a layer of a commercially available clear coat was applied to the layer of transparent top coat, dried and cured. The two layers together formed a top coat on the silver layer.

### Example 2

Analogous to Example 1, a plastic substrate of acrylonitrile-butadiene-styrene (ABS) was provided with a metallically reflective surface and a top coat. The only difference from Example 1: The hydroxy-functional resin used to form the primer layer did not contain benzotriazole or any other equivalent corrosion inhibitor.

### Example 3

Analogous to Example 1, a plastic substrate of acrylonitrile-butadiene-styrene (ABS) was provided with a metallically reflective surface and a top coat. The only difference from Example 1: Instead of the IPDI-based curing agent, a curing agent based on hexamethylene diisocyanate (HDI) was used to produce the top coat.

Objects coated according to Examples 1 and 3 showed a significantly higher corrosion resistance in tests than objects coated according to Example 2 (salt spray test over 240 h with max. 1 mm corrosion creep at the scribe are fulfilled). Objects coated according to Example 3 showed on average lower gloss values (determined at 20° according to DIN 67530 (ISO 2813)) than objects coated according to Example 1.

1-13. (canceled)

14. A method of providing a metallically reflective surface on a substrate comprising:
applying a primer layer to the substrate,
mixing a solution of silver salt with a reducing agent and spraying the solution onto the primer layer to form a silver layer, and
applying at least one transparent or translucent top coat layer or at least one clear coat layer onto the silver layer,
wherein the primer contains a corrosion inhibitor selected from the group consisting of benzotriazole, tolyltriazole, benzimidazole, derivatives of said compounds and mixtures of two or more of said compounds and/or derivatives.

15. The method according to claim 14, wherein the corrosion inhibitor is contained in the primer in a proportion of 0.1 wt. % to 20 wt. %, based on the total mass of the primer.

16. The method according to claim 14, wherein the primer comprises a hydroxy-functional resin and an isocyanate-functional curing agent.

17. The method according to claim 14, wherein the silver salt solution
is an aqueous solution or an aqueous alkaline solution, and/or
contains at least one salt selected from the group consisting of silver nitrate, silver chloride, silver acetate, silver lactate and silver sulfate.

18. The method according to claim 14, wherein the reducing agent is an aqueous solution containing a reducing agent.

19. The method according to claim 14, wherein the substrate is a plastic part or a part made of acrylonitrile-butadiene-styrene, PP/EPDM or a PP copolymer.

20. The method according to claim 14, wherein a surface of the substrate is cleaned and/or pretreated prior to application of the primer.

21. The method according to claim 14, further comprising, subsequent to application of the primer, at least one of steps:
drying and/or at least partial curing the primer layer,
activating the primer layer, and
rinsing with deionized water.

22. The method according to claim 14, further comprising, after application of the metallized layer of silver, at least one of steps:
rinsing with deionized water, and
drying the silver layer.

23. The method according to claim 14, wherein at least one transparent or translucent top coat layer is formed of at least one coating composition comprising a hydroxy-functional resin and an isocyanate-functional curing agent.

24. The method according to claim 23, wherein a transparent or translucent top coat layer is formed of a coating composition comprising an IPDI-based curing agent directly on the silver layer.

25. A layer system on a substrate comprising:
a primer layer directly arranged on the substrate;
a silver layer directly arranged on the primer layer; and
a top coat layer directly arranged on the silver layer,
wherein the primer layer contains a corrosion inhibitor selected from the group consisting of benzotriazole, tolyltriazole, benzimidazole, derivatives of said compounds and mixtures of two or more of said compounds and/or derivatives.

26. A substrate with a layer system on a substrate comprising:
a primer layer directly arranged on the substrate;
a silver layer directly arranged on the primer layer; and
a top coat layer directly arranged on the silver layer,
wherein the primer layer contains a corrosion inhibitor selected from the group consisting of benzotriazole, tolyltriazole, benzimidazole, derivatives of said compounds and mixtures of two or more of said compounds and/or derivatives, obtained by the method according to claim 14.
